(19) United States
(12) Patent Application Publication
(10) Pub. No.: US 2024/0221209 A1
(43) Pub. Date: Jul. 4, 2024

(54) INFORMATION PROCESSOR, INFORMATION PROCESSING METHOD, AND PROGRAM

(71) Applicant: SONY GROUP CORPORATION, TOKYO (JP)

(72) Inventors: HIROTAKA TANAKA, TOKYO (JP); MASATAKA TOYOURA, TOKYO (JP); KOZUE YAMAMOTO, TOKYO (JP); YOSHIYA ASAUMI, TOKYO (JP)

(21) Appl. No.: 18/556,930

(22) PCT Filed: Jan. 17, 2022
(86) PCT No.: PCT/JP2022/001453

§ 371 Date: Oct. 24, 2023

(30) Foreign Application Priority Data
May 14, 2021 (JP) 2021-082675

(51) Int. Cl. G06T 7/73; G01C 21/00; G06T 7/246; G06V 10/762; G06V 20/50

(52) U.S. Cl. CPC G06T 7/73; G01C 21/005; G01C 21/3804; G06T 7/246; G06V 10/762; G06V 20/50; G06T 2207/10028

(57) ABSTRACT

An information processor according to the present disclosure includes: a detection processor that detects, on the basis of output data from a first sensor, a first region within an object detection region detected by the first sensor, the first region being unsuitable for self-location estimation and environment map creation; and a data processor that performs the self-location estimation and the environment map creation on the basis of the output data corresponding to a second region excluding the first region within the object detection region.

### TECHNICAL FIELD

The present disclosure relates to an information processor, an information processing method, and a program that perform self-location estimation.

### BACKGROUND ART

SLAM (Simultaneous Localization and Mapping) is a technique to perform self-location estimation for a robot, an automobile, or the like. According to SLAM, self-location estimation and environment map creation for a robot or the like are performed on the basis of output data from an image sensor and a LiDAR (Light Detection And Ranging) sensor. Meanwhile, a technique to perform tracking (tracking) of a moving object on the basis of output data from a sensor exists (PTL 1).

### CITATION LIST

### Patent Literature

PTL 1: Japanese Unexamined Patent Application Publication No. 2019-211831

### SUMMARY OF THE INVENTION

For example, performing SLAM under an environment where a moving object exists would cause false recognition of self-location estimation, which is called drift. Additionally, a computation load may become large.

It is desirable to provide an information processor, an information processing method, and a program that make it possible to decrease false recognition during self-location estimation and reduce a computation load.

An information processor according to an embodiment of the present disclosure includes: a detection processor that detects, on the basis of output data from a first sensor, a first region within an object detection region detected by the first sensor, the first region being unsuitable for self-location estimation and environment map creation; and a data processor that performs the self-location estimation and the environment map creation on the basis of the output data corresponding to a second region excluding the first region within the object detection region.

An information processing method according to an embodiment of the present disclosure includes: detecting, on the basis of output data from a first sensor, a first region within an object detection region detected by the first sensor, the first region being unsuitable for self-location estimation and environment map creation; and performing the self-location estimation and the environment map creation on the basis of the output data corresponding to a second region excluding the first region within the object detection region.

A program according to an embodiment of the present disclosure causes a computer to execute processing, the processing including: detecting, on the basis of output data from a first sensor, a first region within an object detection region detected by the first sensor, the first region being unsuitable for self-location estimation and environment map creation; and performing the self-location estimation and the environment map creation on the basis of the output data corresponding to a second region excluding the first region within the object detection region.

In an information processor, an information processing method, or a program according to the embodiment of the present disclosure: on the basis of output data from a first sensor, a first region within an object detection region detected by the first sensor is detected, the first region being unsuitable for self-location estimation and environment map creation; and the self-location estimation and the environment map creation are performed on the basis of the output data corresponding to a second region excluding the first region within the object detection region.

### BRIEF DESCRIPTION OF THE DRAWINGS

FIG. 1 is a block diagram illustrating a configuration example of an information processor according to a first embodiment of the present disclosure.

FIG. 2 is a block diagram illustrating a first application example of the information processor according to the first embodiment.

FIG. 3 is a block diagram illustrating a second application example of the information processor according to the first embodiment.

FIG. 4 is an explanatory diagram schematically illustrating an example of a region (a SLAM region) where SLAM is to be performed and a region (a tracking region) where tracking of a moving object is to be performed in the information processor according to the first embodiment.

FIG. 5 is a flowchart illustrating an example of a flow of a processing operation for performing SLAM and tracking of a moving object in the information processor according to the first embodiment.

FIG. 6 is a flowchart subsequent to FIG. 5.

FIG. 7 is a block diagram illustrating a configuration example of the information processor according to Modification Example 1 of the first embodiment.

FIG. 8 is a block diagram illustrating a configuration example of the information processor according to Modification Example 2 of the first embodiment.

FIG. 9 is a block diagram illustrating a configuration example of the information processor according to Modification Example 3 of the first embodiment.

### MODES FOR CARRYING OUT THE INVENTION

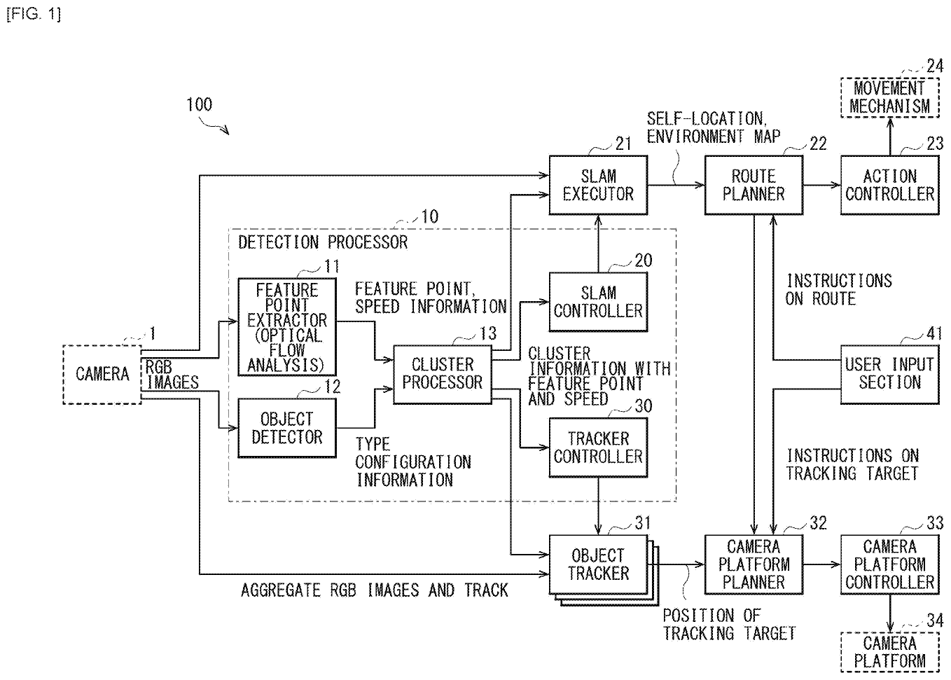

In the following, some embodiments of the present disclosure are described in detail with reference to the drawings. It should be noted that description is made in the following order.
1. First Embodiment (FIG. 1 to FIG. 9)
1.0 Comparative Example
1.1 Configuration
1.2 Operation
1.3 Modification Examples
1.4 Effects
2. Other Embodiments

### 1. FIRST EMBODIMENT

### 1.0 Comparative Example

In a case where SLAM and tracking (tracking) of a moving object are to be simultaneously performed, it is typical that a sensor for SLAM and a sensor for performing tracking of a moving object are separately provided and data processing is also separately performed. For example, in a case where it is desired to cause a camera-equipped mobile body such as a drone to photograph an artist ahead who is performing on a stage while avoiding obstacles on the right and left sides and behind, it is difficult to simultaneously perform SLAM and tracking of the artist as a moving object using the single camera only. Additionally, photographing for SLAM and photographing for tracking of a moving object are different in direction and range of photographing in some cases. Accordingly, it is common that a mobile body is usually equipped with a camera dedicated to SLAM and a camera dedicated to tracking. In a case where a plurality of cameras is used to perform SLAM and tracking of a moving object, a designer or a user of the mobile body determines which camera is to be used. It should be noted that “tracking” means an act of tracking a moving object in the real world in the present embodiment. Although a pixel-by-pixel-based or frame-by-frame-based tracking is also performed during an internal calculation of SLAM, it refers to tracking merely in the calculation and is different from an act of tracking a moving object in the real world.

In addition, an image pixel and point cloud information obtained by photographing a moving object are unsuitable for SLAM. Calculation of SLAM is usually performed by using not absolute coordinates but relative coordinates as a reference, which provides an illusion of movement of a self-location irrespective of no actual movement. For this reason, performing SLAM under an environment where a moving object exists would cause false recognition of self-location estimation called drift. Additionally, the computation load may become large. Thus, it is usually difficult to perform SLAM while tracking a moving object.

Accordingly, the present embodiment provides a technique including performing SLAM with exclusion of a moving object, which makes it possible to decrease false recognition during a self-location estimation and reduce a computation load. Further, a technique that makes it possible to track a moving object while performing SLAM is provided.

### 1.1 Configuration

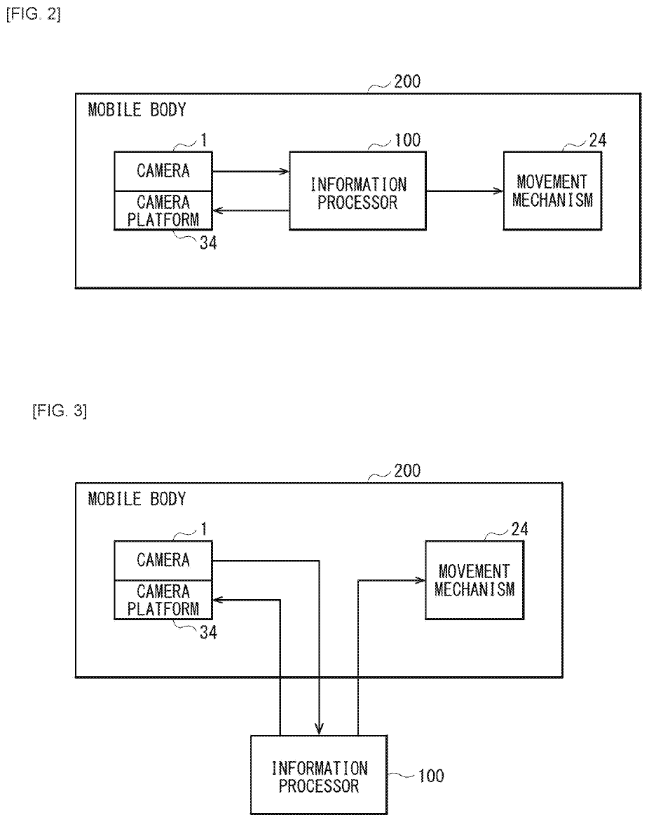

FIG. 1 illustrates a configuration example of an information processor 100 according to a first embodiment of the present disclosure. FIG. 2 illustrates a first application example of the information processor 100 according to the first embodiment. FIG. 3 illustrates a second application example of the information processor 100 according to the first embodiment.

The information processor 100 according to the first embodiment is usable in a mobile body 200. The mobile body 200 includes, for example, a camera 1 in which an attitude is controllable with a camera platform 34 and a movement mechanism 24 able to cause the mobile body 200 to move as illustrated in FIG. 2 and FIG. 3. The information processor 100 may be provided in the mobile body 200 itself as illustrated in FIG. 2 or may be provided outside the mobile body 200 as illustrated in FIG. 3. In a case where being provided outside the mobile body 200, the information processor 100 is configured to be able to communicate with the mobile body 200 by wire or wirelessly. Examples of the mobile body 200 in which the information processor 100 is used include a robot, a drone, a vehicle equipped with an ADAS (Advanced Driver Assistance System) in addition to an AGV (Automated Guided Vehicle), or the like.

It should be noted that the technique of the present disclosure is also applicable to a variety of immovable devices without limitation to the mobile body 200. For example, the technique is also applicable to an assembly robot in a factory, or the like.

The information processor 100 may be in a form of, for example, a computer including a CPU (Central Processing Unit), a ROM (Read Only Memory), and a RAM. In this case, various types of processing of the information processor 100 are implementable by the CPU executing processing based on a program stored in the ROM or the RAM. Additionally, the various types of processing of the information processor 100 may be implemented by, for example, the CPU executing processing based on a program externally supplied through a network by wire or wirelessly.

The information processor 100 includes a detection processor 10, a SLAM executor 21, a route planner 22, an action controller 23, an object tracker 31, a camera platform planner 32, a camera platform controller 33, and a user input section 41.

The camera 1 corresponds to a specific example of a “first sensor” of the technique of the present disclosure. The camera 1 is an image sensor configured to output image data as output data. The camera 1 outputs, for example, RGB image data including image data regarding each of R (red), G (green), and B (blue).

The detection processor 10 includes a feature point extractor 11, an object detector 12, a cluster processor 13, a SLAM controller 20, and a tracker controller 30.

The detection processor 10 detects a SLAM exclusion region as a first region on the basis of the image data from the camera 1, and the first image is unsuitable for SLAM (self-location estimation and environment map creation) for the mobile body 200 within an object detection region detected by the camera 1.

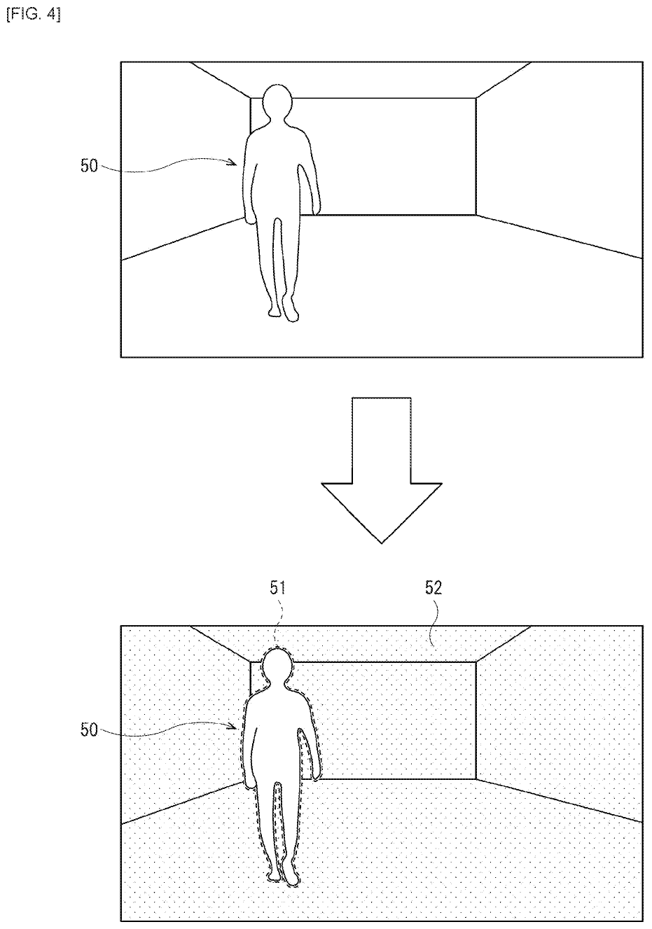

FIG. 4 schematically illustrates an example of a region where SLAM is to be performed (a SLAM region 52) and a region where tracking of a moving object 50 is to be performed (a tracking region 51) within an object detection region detected by the camera 1.

In the first embodiment, the SLAM exclusion region within the object detection region detected by the camera 1 is usable as the tracking region 51 of the object tracker 31 for the moving object 50 as illustrated in FIG. 4. The detection processor 10 may detect, as the SLAM exclusion region (the tracking region 51), a region where the moving object 50 exists within the object detection region. The detection processor 10 may detect the region where the moving object 50 exists on the basis of speed information. The detection processor 10 may calculate the speed information by causing the feature point extractor 11 to perform optical flow analysis of the image data.

Additionally, the detection processor 10 may detect the region where the moving object 50 exists on the basis of object detection by shape recognition or the like. For example, a region where a shape estimated to be a shape (human face or joint or the like) of the moving object 50 is recognized may be detected as the region where the moving object 50 exists. Alternatively, the region where the moving object 50 exists may be detected on the basis of a feature amount of a pattern or the like without limitation to shape.

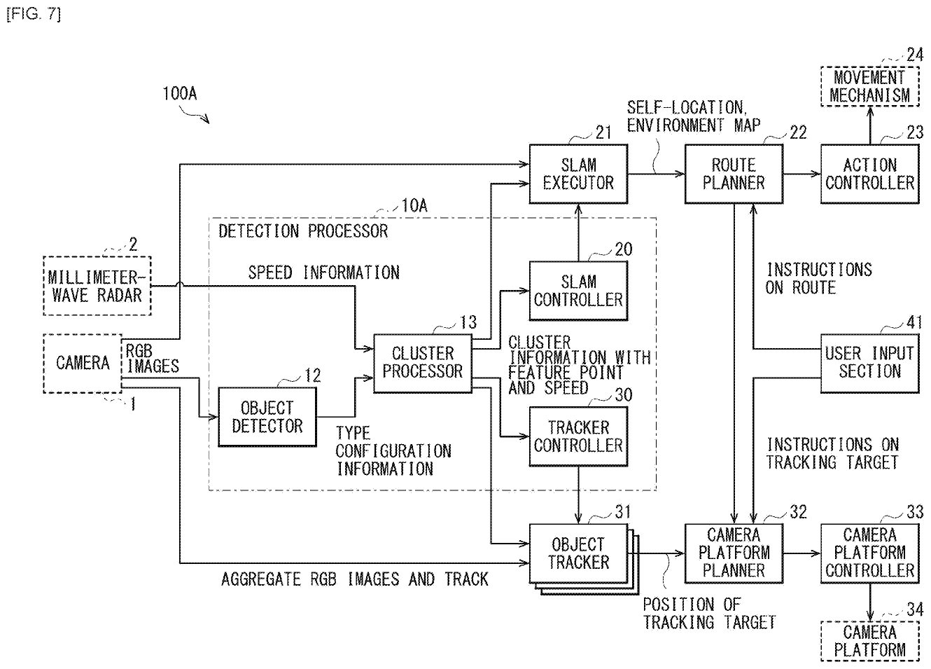

Additionally, the detection processor 10 may determine whether or not each cluster generated by the cluster processor 13 is the SLAM exclusion region. The detection processor 10 may cause the cluster processor 13 to generate no cluster for a region where data sufficient for the cluster processor 13 to perform clustering fails to be obtained. For example, no cluster may be generated for a region that is less reliable due to a small number of pixels of the image data from the camera 1, a lot of noise, or the like. Additionally, in a case where a millimeter-wave radar 2 or a LiDAR (Light Detection And Ranging) sensor is used to acquire point cloud information as in later-described modification examples (FIG. 7 to FIG. 9), no cluster may be generated for a region that is less reliable in point cloud information due to a case of a failure in obtaining a sufficient number of point clouds, or the like. In this case, for the region for which no cluster is generated, neither processing of calculation and determination for tracking of the moving object 50 by the object tracker 31 nor execution of SLAM by the SLAM executor 21 may be performed.

The feature point extractor 11 performs extraction of a feature point of an object within the object detection region detected by the camera 1 and optical flow analysis on the basis of the image data from the camera 1 and outputs information regarding the feature point and speed information.

The object detector 12 detects the object within the object detection region detected by the camera 1 on the basis of the image data from the camera 1 and outputs type configuration information indicating the type and configuration of the object.

The cluster processor 13 performs clustering (grouping) of the object detected within the object detection region into at least one cluster on the basis of the information regarding the feature point and the speed information from the feature point extractor 11 and the type configuration information from the object detector 12 and outputs cluster information with a feature point and a speed.

The SLAM controller 20 controls execution of SLAM by the SLAM executor 21 on the basis of the cluster information from the cluster processor 13.

The SLAM executor 21 corresponds to a specific example of a “data processor” of the technique of the present disclosure. The SLAM executor 21 integrates the respective images of R, G, and B from the camera 1 and executes SLAM in accordance with a control of the SLAM controller 20. The SLAM executor 21 performs self-location estimation and environment map creation for the mobile body 200 on the basis of the image data from the camera 1 corresponding to the SLAM region 52 as a second region where the SLAM exclusion region within the object detection region is excluded, and outputs information regarding the self-location of the mobile body 200 and information regarding the environment map.

The tracker controller 30 integrates the images of the respective colors of R, G, and B from the camera 1 and controls, on the basis of the cluster information from the cluster processor 13, calculation and determination for tracking by the object tracker 31.

The object tracker 31 corresponds to a specific example of a “tracking section” of the technique of the present disclosure. The object tracker 31 performs calculation and determination for tracking the moving object 50 in accordance with a control of the tracker controller 30 and outputs information regarding a position of the moving object 50 that is a tracking target. The object tracker 31 performs calculation and determination for tracking the moving object 50 on the basis of the image data from the camera 1 corresponding to the SLAM exclusion region. A plurality of object trackers 31 may be provided. Using the plurality of object trackers 31, calculation and determination for tracking a plurality of moving objects 50 may be performed.

The user input section 41 receives instructions on route and instructions on tracking target provided by a user. The user input section 41 outputs the instructions on route provided by the user to the route planner 22. The user input section 41 outputs the instructions on tracking target provided by the user to the camera platform planner 32. Possible examples of the instructions on tracking target provided by the user include defining the moving object 50 closest to the mobile body 200 as a tracking target and defining, in a case of photographing an artist, or the like, the moving object 50 as a tracking target to cause a composition to be set as intended by a director of photography.

The route planner 22 performs action planning for the mobile body 200 on the basis of the instructions on route provided by the user and the information regarding the self-location and the information regarding the environment map from the SLAM executor 21.

The action controller 23 controls an action of the mobile body 200 by controlling the movement mechanism 24 of the mobile body 200 on the basis of the action planning by the route planner 22.

The camera platform planner 32 performs planning for an attitude control of the camera platform 34 on the basis of the instructions on tracking target provided by the user and information regarding a position of the tracking target from the object tracker 31.

The camera platform controller 33 controls an attitude of the camera platform 34 on the basis of a plan of the attitude control of the camera platform 34 provided by the camera platform planner 32.

### 1.2 Operation

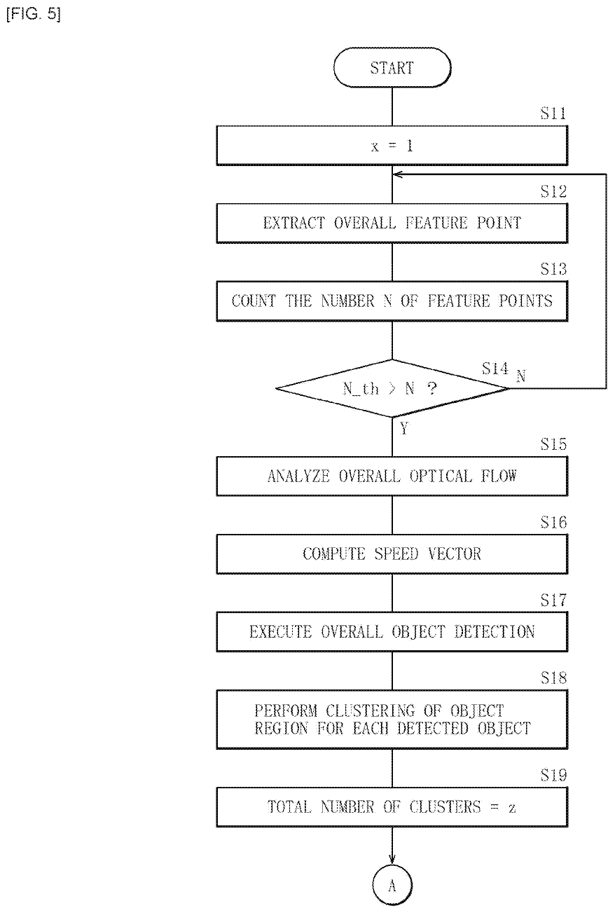

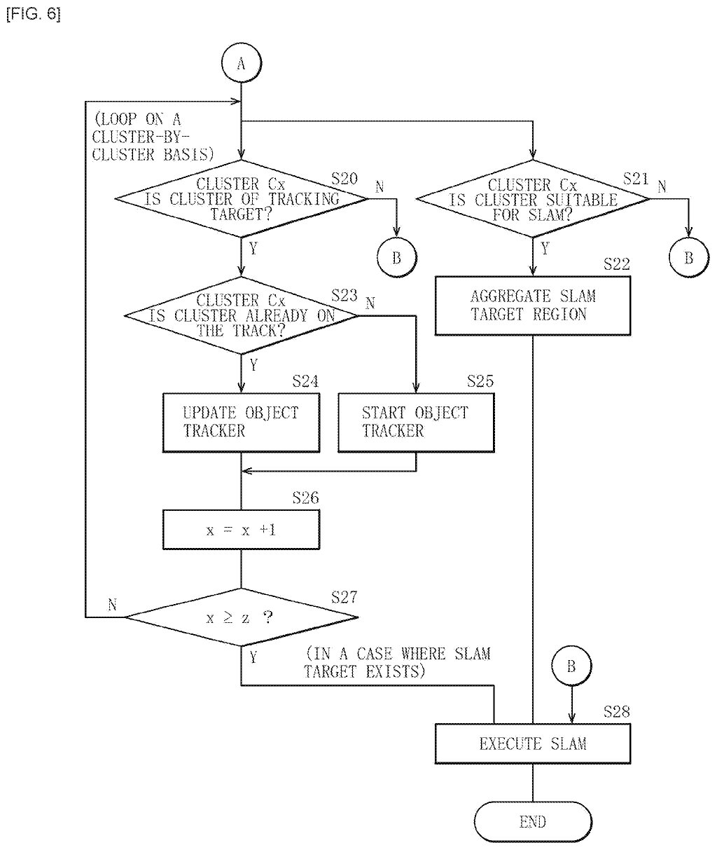

FIG. 5 is a flowchart illustrating an example of a flow of a processing operation for performing SLAM and tracking of the moving object 50 in the information processor 100 according to the first embodiment. FIG. 6 is a flowchart subsequent to FIG. 5.

First, the detection processor 10 sets a parameter x for identifying a cluster Cx generated by the cluster processor 13 at 1 (x=1) (step S11). Subsequently, the detection processor 10 extracts feature points all over an object detection region detected by the camera 1 (step S12). The detection processor 10 then counts the number N of the extracted feature points (step S13).

The detection processor 10 then determines whether or not the number N of the feature points exceeds a predetermined threshold N_th (N_th >N) (step S14). It should be noted that a value of score (Confidence) usually usable for a technique of image recognition may be used in addition to the number N of the feature points. Accordingly, in a case where, for example, a person is to be recognized as a moving object, it may be determined whether or not a “score of similarity to a human face” is detected. In a case of determining that the number N of the feature points does not exceed the predetermined threshold N_th (step S14; N), the detection processor 10 returns to the processing in step S12. In contrast, in a case of determining that the number N of the feature points exceeds the predetermined threshold N_th (step S14; Y), the detection processor 10 then causes the feature point extractor 11 to analyze an overall optical flow (step S15). The detection processor 10 then causes the feature point extractor 11 to compute a speed vector as speed information regarding the feature points (step S16). It should be noted that in a case where the millimeter-wave radar 2 or a LiDAR (Light Detection And Ranging) sensor is used as in the later-described modification examples (FIG. 7 to FIG. 9), the speed information regarding the feature points is acquirable directly from the millimeter-wave radar 2 or the LiDAR sensor, which eliminates the necessity of the optical flow analysis.

The detection processor 10 then performs overall object detection (step S17). The detection processor 10 then performs clustering of an object region for each detected object (step S18). It should be noted that for a region where data sufficient for clustering fails to be obtained, the cluster processor 13 may generate no cluster. The detection processor 10 then defines the total number of clusters as z (step S19). After that, the information processor 100 simultaneously performs processing of SLAM and tracking processing for the moving object 50 in parallel.

The tracker controller 30 then determines whether or not the cluster Cx is a cluster of a tracking target (step S20). In parallel with this, the SLAM controller 20 also determines whether or not the cluster Cx is a cluster suitable for SLAM (step S21).

In a case of determining that the cluster Cx is not a cluster suitable for SLAM in step S21 (step S21; N), the SLAM controller 20 then proceeds to processing in step S28. In contrast, in a case of determining that the cluster Cx is a cluster suitable for SLAM (step S21; Y), the SLAM controller 20 then proceeds to the processing in step S28 after aggregating a SLAM target region (step S22).

Meanwhile, in a case of determining that the cluster Cx is not a cluster of the tracking target in step S20 (step S20; N), the tracker controller 30 then proceeds to the processing in step S28. In contrast, in a case of determining that the cluster Cx is a cluster of the tracking target (step S20; Y), the tracker controller 30 then determines whether or not the cluster Cx is a cluster that is already on the track (step S23).

In a case of determining that the cluster Cx is a cluster that is already on the track in step S23 (step S23; Y), the tracker controller 30 then proceeds to processing in step S26 after updating the object tracker 31 (step S24). In contrast, in a case of determining that the cluster Cx is not a cluster that is already on the track (being tracked) (step S23; N), the tracker controller 30 then proceeds to the processing in step S26 after starting a new object tracker 31 (step S25).

In step S26, the detection processor 10 sets the parameter x for identifying the cluster Cx at +1 (x=x+1). The detection processor 10 then determines whether or not the parameter x reaches the total number z of clusters or more (x ≥z) (step S27). In a case of determining that the parameter x reaches the total number z of clusters or more (step S27; Y), the detection processor 10 terminates the processing after proceeding to processing in step S28. In contrast, in a case of determining that the parameter x does not reach the total number z of clusters or more (step S27; N), the detection processor 10 returns to processing in Steps S20 and S21. In step S28, the SLAM executor 21 applies SLAM to the SLAM target region in accordance with the control of the SLAM controller 20.

### 1.3 Modification Examples

### Modification Example 1

FIG. 7 illustrates a configuration example of an information processor 100A according to Modification Example 1 of the first embodiment.

The information processor 100A according to Modification Example 1 is usable in a case where the mobile body 200 includes the camera 1 as the first sensor and the millimeter-wave radar 2 as the second sensor. Output data from the camera 1 and output data from the millimeter-wave radar 2 are to be inputted to the information processor 100A. The output data from the millimeter-wave radar 2 includes speed information and point cloud data. Accordingly, the feature point extractor 11 for calculating speed information is omitted from a configuration of a detection processor 10A of the information processor 100A. The speed information and the point cloud data included in the output data from the millimeter-wave radar 2 are to be inputted to the cluster processor 13. The cluster processor 13 performs clustering (grouping) of an object detected within an object detection region detected by the camera 1 into at least one cluster on the basis of the speed information and the point cloud data included in the output data from the millimeter-wave radar 2 and type configuration information from the object detector 12 and outputs cluster information with a speed.

### Modification Example 2

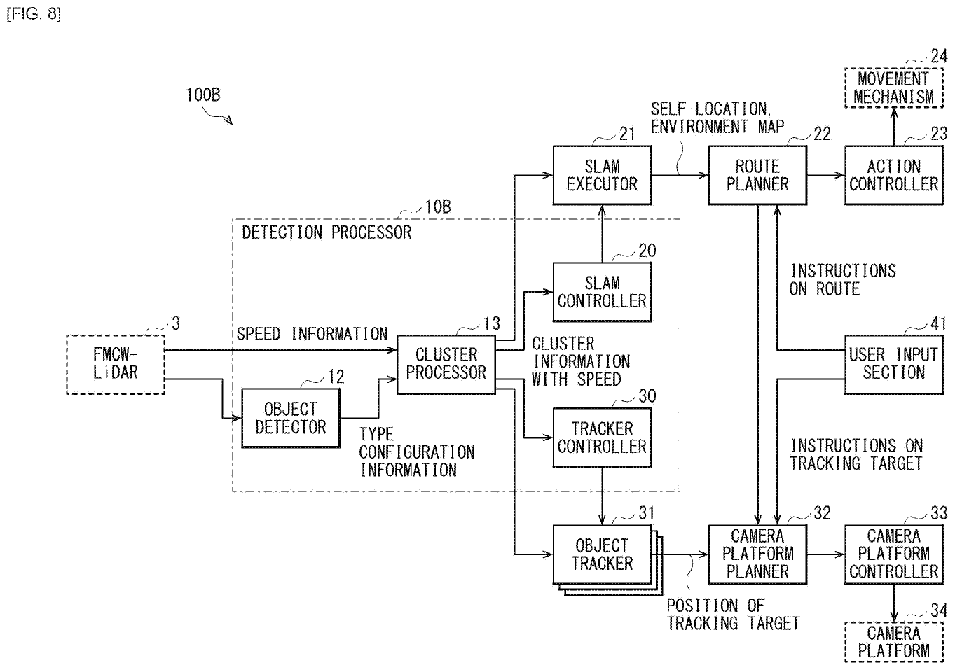

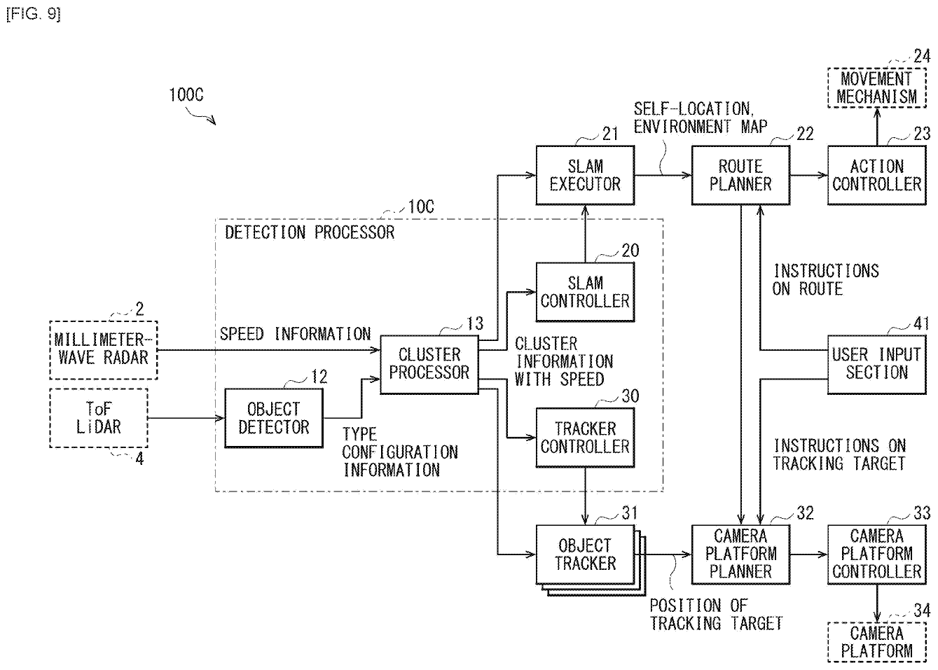

FIG. 8 illustrates a configuration example of an information processor 100B according to Modification Example 2 of the first embodiment.

The information processor 100B according to Modification Example 2 is usable in a case where the mobile body 200 includes an FMCW (Frequency Modulated Continuous Wave)-LiDAR 3 in place of the camera 1. Output data from the FMCW-LiDAR 3 is to be inputted to the information processor 100B. The output data from the FMCW-LiDAR 3 includes speed information and point cloud data. Accordingly, the feature point extractor 11 for calculating speed information is omitted from a configuration of a detection processor 10B of the information processor 100B. The object detector 12 detects, on the basis of the output data from the FMCW-LiDAR 3, an object within an object detection region detected using the output data and outputs type configuration information indicating the type and configuration of the object. The speed information and the point cloud data included in the output data from the FMCW-LiDAR 3 are to be inputted to the cluster processor 13. The cluster processor 13 performs clustering (grouping) of the object detected within the object detection region detected by the FMCW-LiDAR 3 into at least one cluster on the basis of the speed information and the point cloud data included in the output data from the FMCW-LiDAR 3 and the type configuration information from the object detector 12 and outputs cluster information with a speed.

### Modification Example 3

FIG. 9 illustrates a configuration example of an information processor 100C according to Modification Example 3 of the first embodiment.

The information processor 100C according to Modification Example 3 is usable in a case where the mobile body 200 includes a ToF (Time of Flight) LiDAR 4 as the first sensor in place of the camera 1 and further includes the millimeter-wave radar 2 as the second sensor. Output data from the ToF LiDAR 4 and output data from the millimeter-wave radar 2 are to be inputted to the information processor 100C. The output data from the millimeter-wave radar 2 includes speed information and point cloud data. Accordingly, the feature point extractor 11 for calculating speed information is omitted from a configuration of a detection processor 10C of the information processor 100C. The object detector 12 detects, on the basis of the output data from the ToF LiDAR 4, an object within an object detection region detected using the output data and outputs type configuration information indicating the type and configuration of the object. The speed information and the point cloud data included in the output data from the millimeter-wave radar 2 are to be inputted to the cluster processor 13. The cluster processor 13 performs clustering (grouping) of the object detected within the object detection region detected by the ToF LiDAR 4 into at least one cluster on the basis of the speed information and the point cloud data included in the output data from the millimeter-wave radar 2 and the type configuration information from the object detector 12, and outputs cluster information with a speed.

### 1.4 Effects

As described hereinabove, in the information processor 100 according to the first embodiment, a first region (a SLAM exclusion region) unsuitable for self-location estimation and environment map creation of the object 200 is detected and the self-location estimation and environment map creation of the mobile body 200 are to be performed on the basis of output data corresponding to a second region (the SLAM region 52) excluding the first region within an object detection region. This makes it possible to decrease false recognition during the self-location estimation of the mobile body 200 and reduce a computation load even under an environment where, for example, the moving object 50 exists.

In addition, in the information processor 100 according to the first embodiment, in a case where the moving object 50 exists, the SLAM exclusion region is used as a region (the tracking region 51) where tracking of the moving object 50 is to be performed, which makes it possible to track the moving object 50 while performing SLAM. This makes it possible to make a determination not by a user him/herself but automatically that, for example, only a moving object and a large object are to be tracked as tracking targets and none of the other objects is to be subjected to SLAM as considered as being unnecessary to track. Such elimination of the necessity of a determination of a user is contributable to saving of manpower. Additionally, SLAM and tracking of the moving object 50 are performable merely by at least one sensor, which is contributable to a reduction in costs of the mobile body 200 and power saving.

Additionally, in a case of applying the information processor 100 according to the first embodiment to a drone or an AGV as the mobile body 200, it is possible to automatically photograph and automatically track, for example, an artist on a stage. Additionally, in a case of applying it to an ADAS (advanced driver assistance system) as the mobile body 200, it is possible to reduce, for example, human error in determination before it happens.

It should be noted that the effects described herein are merely by way of example and not limiting and any other effect is also possible. The same applies to effects of other embodiments hereinbelow.

### 2. OTHER EMBODIMENTS

The technique according to the present disclosure is not limited to the foregoing descriptions of the embodiment and is implementable with a variety of modifications.

For example, the present technology may have the following configuration.

The present technology with the following configuration includes detecting a first region unsuitable for self-location estimation and environment map creation and performing self-location estimation and environment map creation on the basis of output data corresponding to a second region excluding the first region within an object detection region.

This makes it possible to decrease false recognition during the self-location estimation and reduce a computation load.

(1)

An information processor including:
a detection processor that detects, on the basis of output data from a first sensor, a first region within an object detection region detected by the first sensor, the first region being unsuitable for self-location estimation and environment map creation; and
a data processor that performs the self-location estimation and the environment map creation on the basis of the output data corresponding to a second region excluding the first region within the object detection region.
   (2)

The information processor according to (1), in which the detection processor detects, as the first region, a region where a moving object exists within the object detection region.

(3)

The information processor according to (2), further including a tracking section that performs calculation and determination for tracking the moving object on the basis of the output data corresponding to the first region.

(4)

The information processor according to (2) or (3), in which the detection processor detects the region where the moving object exists on the basis of speed information.

(5)

The information processor according to (4), in which
the first sensor includes an image sensor configured to output image data as the output data, and
the detection processor calculates the speed information by performing optical flow analysis of the image data.
   (6)

The information processor according to (4), in which the first sensor includes a LiDAR (Light Detection And Ranging) sensor configured to output the speed information.

(7)

The information processor according to (4), in which the detection processor acquires the speed information from a second sensor.

(8)

The information processor according to (2) or (3), in which the detection processor detects the region where the moving object exists on the basis of object detection.

(9)

The information processor according to any one of (1) to (8), in which
the detection processor includes a cluster processor that performs clustering of an object detected within the object detection region into at least one cluster, and
the detection processor determines whether or not each of the clusters generated by the cluster processor is the first region.
   (10)

The information processor according to (9), in which the detection processor does not generate the cluster for a region where no data sufficient for the cluster processor to perform the clustering is obtained.

(11)

The information processor according to any one of (1) to (10), in which the information processor is provided in a mobile body.

(12)

An information processing method including:
detecting, on the basis of output data from a first sensor, a first region within an object detection region detected by the first sensor, the first region being unsuitable for self-location estimation and environment map creation; and
performing the self-location estimation and the environment map creation on the basis of the output data corresponding to a second region excluding the first region within the object detection region.
   (13)

A program that causes a computer to execute processing, the processing including:
detecting, on the basis of output data from a first sensor, a first region within an object detection region detected by the first sensor, the first region being unsuitable for self-location estimation and environment map creation; and
performing the self-location estimation and the environment map creation on the basis of the output data corresponding to a second region excluding the first region within the object detection region.

This application claims the benefit of Japanese Priority Patent Application JP2021-82675 filed with the Japan Patent Office on May 14, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An information processor comprising:
a detection processor that detects, on a basis of output data from a first sensor, a first region within an object detection region detected by the first sensor, the first region being unsuitable for self-location estimation and environment map creation; and
a data processor that performs the self-location estimation and the environment map creation on a basis of the output data corresponding to a second region excluding the first region within the object detection region.

2. The information processor according to claim 1, wherein the detection processor detects, as the first region, a region where a moving object exists within the object detection region.

3. The information processor according to claim 2, further comprising a tracking section that performs calculation and determination for tracking the moving object on a basis of the output data corresponding to the first region.

4. The information processor according to claim 2, wherein the detection processor detects the region where the moving object exists on a basis of speed information.

5. The information processor according to claim 4, wherein
the first sensor comprises an image sensor configured to output image data as the output data, and
the detection processor calculates the speed information by performing optical flow analysis of the image data.

6. The information processor according to claim 4, wherein the first sensor comprises a LiDAR (Light Detection And Ranging) sensor configured to output the speed information.

7. The information processor according to claim 4, wherein the detection processor acquires the speed information from a second sensor.

8. The information processor according to claim 2, wherein the detection processor detects the region where the moving object exists on a basis of object detection.

9. The information processor according to claim 1, wherein
the detection processor includes a cluster processor that performs clustering of an object detected within the object detection region into at least one cluster, and
the detection processor determines whether or not each of the clusters generated by the cluster processor is the first region.

10. The information processor according to claim 9, wherein the detection processor does not generate the cluster for a region where no data sufficient for the cluster processor to perform the clustering is obtained.

11. The information processor according to claim 1, wherein the information processor is provided in a mobile body.

12. An information processing method comprising:
detecting, on a basis of output data from a first sensor, a first region within an object detection region detected by the first sensor, the first region being unsuitable for self-location estimation and environment map creation; and
performing the self-location estimation and the environment map creation on a basis of the output data corresponding to a second region excluding the first region within the object detection region.

13. A program that causes a computer to execute processing, the processing comprising:
detecting, on a basis of output data from a first sensor, a first region within an object detection region detected by the first sensor, the first region being unsuitable for self-location estimation and environment map creation; and
performing the self-location estimation and the environment map creation on a basis of the output data corresponding to a second region excluding the first region within the object detection region.
